(19) United States
(12) Patent Application Publication
(10) Pub. No.: US 2026/0251394 A1
(43) Pub. Date: Aug. 27, 2026

(54) GRAPHITIZATION FURNACE

(71) Applicant: BIRLA CARBON U.S.A. INC., Marietta, GA (US)

(72) Inventors: Charles Schenck Wiley, Marietta, GA (US); Alison Houseman, Marietta, GA (US); Robert Lewczuk, Marietta, GA (US); Zachary Combs, Marietta, GA (US)

(21) Appl. No.: 18/875,940

(22) PCT Filed: Jun. 22, 2023
(86) PCT No.: PCT/US2023/025965

§ 371 Date: Dec. 17, 2024

Related U.S. Application Data
(60) Provisional application No. 63/354,521, filed on Jun. 22, 2022.
(60) Provisional application No. 63/354,526, filed on Jun. 22, 2022.
(60) Provisional application No. 63/479,573, filed on Jan. 12, 2023.
(60) Provisional application No. 63/479,571, filed on Jan. 12, 2023.

(51) Int. Cl. F27B 9/06; F27B 9/12; F27B 9/32; F27B 9/38; F27B 9/39; F27B 9/40

(52) U.S. Cl. CPC F27B 9/063; F27B 9/12; F27B 9/32; F27B 9/38; F27B 9/39; F27B 9/40; F27B 2009/124; F27B 2009/382; F27B 2009/384

(57) ABSTRACT

A furnace comprising: a gravity-fed reactor having: an inner tube defining an interior; a heating assembly that circumferentially surrounds at least a portion of the inner tube, wherein the heating assembly has at least one heating element that is configured to apply heat to the inner tube; an outer shell that defines at least a lower portion of a gas pathway that circumferentially surrounds the heating assembly; and a feed structure configured to receive feedstock, the feed structure defining a feedstock receiving space that is in communication with the interior of the inner tube of the reactor, wherein the interior of the inner tube of the reactor is fluidly isolated from the heating assembly and the gas pathway.

### CROSS-REFERENCE TO RELATED APPLICATIONS

This application claims priority to U.S. Provisional Application Nos. 63/354,521 and 63/354,526, both filed Jun. 22, 2022, and to U.S. Provisional Application Nos. 63/479,573 and 63/479,571, both filed Jan. 12, 2023. Each of these priority applications is incorporated into this application by reference.

### BACKGROUND

The current graphite supply in the United States is less than 10 metric kilotons. Given the growing electric vehicle market among other end uses, reports have suggested that the demand for graphite will increase to 30 kilotons by 2030. Most existing anode-grade graphite is produced through processes that suffer from a number of drawbacks. The most common thermal process involves the use of an Acheson-type furnace. These furnaces are not only extremely dangerous due to high risk of electric shock but are also limited to batch processes and are labor and energy intensive. A typical Acheson-type process often results in as much as 30% of graphitizable feedstock that is discarded as landfill waste.

Processes for making natural or hybrid natural/synthetic graphite suffer from similar disadvantages. A typical acid leaching process for preparing natural graphite requires chemical consumables, and results in significant pollution if waste stream are not adequately diverted to water treatment plants. Batch induction furnace and continuous heat-treatment processes are energy intensive and typically require expensive and inefficient power supply technology and frequent component replacement. There is a need for improved methods for graphitizing material that suitable for a number of end uses included as anode-grade graphite materials.

### SUMMARY

This disclosure relates to a graphite furnace and methods of using the furnace to efficiently and cost-effectively graphitize a feedstock material using heat treatment.

Embodiments of the disclosed furnace comprise a gravity-fed reactor having: (a) an inner tube defining an interior; (b) a heating assembly that circumferentially surrounds at least a portion of the inner tube, the heating assembly having at least one heating element that is configured to apply heat to the inner tube; (c) an outer shell that defines at least a lower portion of a gas pathway that circumferentially surrounds the heating assembly; and (d) a feed structure configured to receive feedstock, the feed structure defining a feedstock receiving space that is in communication with the interior of the inner tube of the reactor. In one embodiment, the interior of the inner tube of the reactor is fluidly isolated from the heating assembly and the gas pathway.

Also described are methods of using the furnace, for example to convert graphitizable feedstock to graphite at high temperatures. The resulting graphite can be used in a variety of applications including as electrodes for electric vehicles.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 is diagram of an exemplary embodiment of the graphitization furnace.

FIG. 2 is a cross-sectional view of an embodiment of the gravity-fed reactor (including a partial cross-sectional view of the upper feed structure)

FIG. 3 is a cross-sectional view of an embodiment of the feed structure and feedstock transfer system.

FIG. 4 is a diagram of an exemplary embodiment of the aftercooler assembly and conveyor assembly.

FIG. 5 is another diagram of an exemplary embodiment of the aftercooler assembly and conveyor assembly.

FIG. 6 is a diagram an exemplary embodiment of the mass flow screw of the conveyor assembly.

FIG. 7 is a diagram of an exemplary alternative embodiment of the aftercooler assembly and conveyor assembly.

FIG. 8 is a photograph of the valve positioned between the outlet of the aftercooler assembly and the conveyor assembly.

FIG. 9 is a diagram of an exemplary alternative embodiment of the aftercooler assembly and conveyor assembly.

FIG. 10 is a diagram of an exemplary alternative embodiment of the aftercooler assembly and conveyor assembly.

FIG. 11 shows plots illustrating the temperature profile in an exemplary embodiment of the furnace, showing highly uniform temperatures in the furnace's hot zone (the interior of inner tube of gravity-fed reactor).

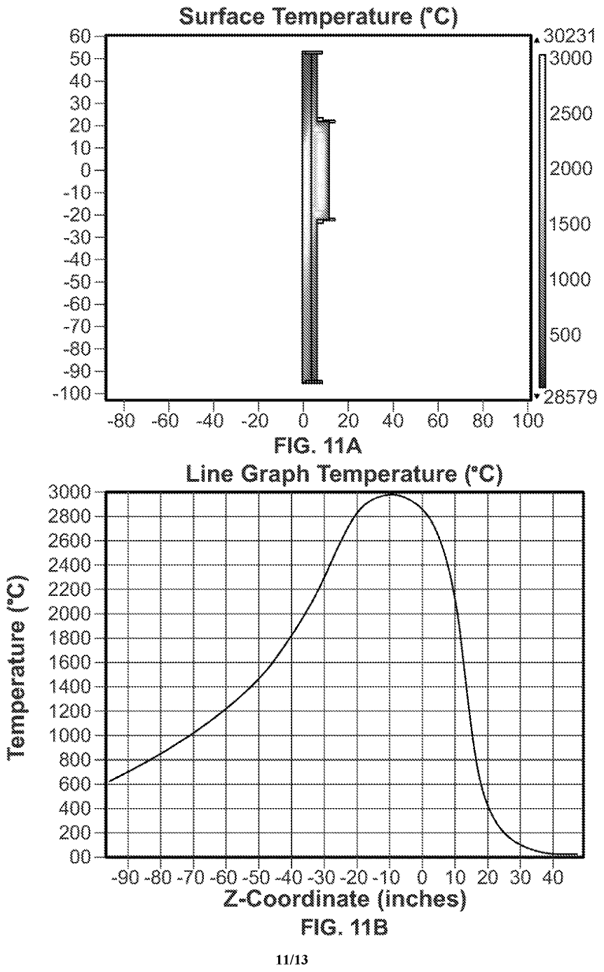

FIG. 12 is a plot showing 18,650 full cell testing with synthetic graphite prepared with an embodiment of the disclose graphitization furnace compared to a widely used synthetic graphite. (Top) Long-term cycling at a C/3 constant current charging rate between 3.0 and 4.2 V. (Bottom) High precision coulometry, which measures the coulombic inefficiency of the full cells.

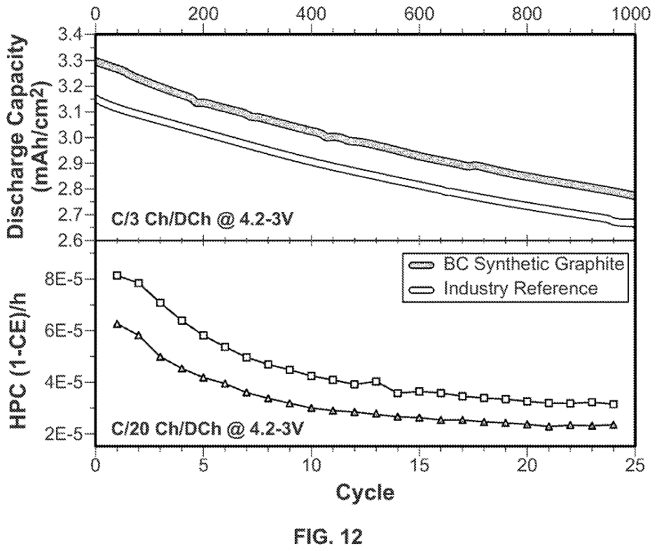

FIG. 13 is a diagram of an exemplary embodiment of the graphitization characterization device.

### DETAILED DESCRIPTION

The following exemplary embodiments illustrate this disclosure. The scope of the disclosure and claims is not limited by the scope of the following embodiments.

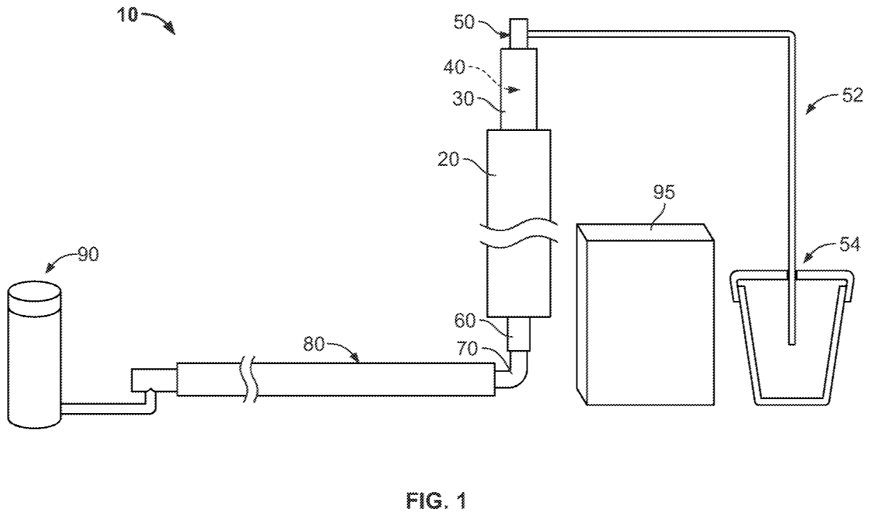

One exemplary embodiment of the graphitization furnace is depicted in FIG. 1. Graphitization furnace 10 includes gravity-fed reactor 20. Gravity-fed reactor 20 can be designed to graphitize a graphitizable material at extremely high temperatures, e.g., 2000-3000° C. Graphitizable material enters gravity-fed reactor 20 through feed structure 30, which defines feedstock receiving space (40) that is in communication with the interior of an inner tube of gravity-fed reactor 20 (interior tube not shown in FIG. 1). Feedstock is transferred to feed structure 30 though feedstock transfer system 50, which is in fluid communication with feedstock receiving space 40 of feed structure 30.

Embodiments of feedstock transfer system 50 are designed to accept feedstock, evacuate the interior space defined by at least a portion of feedstock transfer system 50, and backfill the interior space with an inert gas such as argon. This ensures that ambient air does not enter feedstock receiving space (40), which in turn ensures that the atmosphere in the interior of the inner tube of gravity-fed reactor 20 remains inert during graphitization.

Various mechanisms for feeding graphitizable material into feedstock transfer system 50 are contemplated. In the embodiment depicted in FIG. 1, graphitizable material is fed into feedstock transfer system 50 from pneumatic tube 52, which pulls feedstock from feedstock reservoir 54. In various embodiments, pneumatic tube 52 and feedstock reservoir 54 are substantially sealed or sealed from the ambient air. An advantage of pneumatic tube 52 and feedstock reservoir 54 is that the inlet feed system is not screw fed.

During operation, graphitization furnace 10 can operate in a continuous temperature regime. In some embodiments, material can be graphitized at rates up to and exceeding 15 kg/hour, with graphitized material continuously exiting graphitization furnace 10. In some embodiments, feedstock can be introduced to graphitization furnace 10 in either a continuous or batch-wise manner. In one embodiment, for example, graphitized material can exit graphitization furnace 10 while graphitizable material is simultaneously being fed into graphitization furnace 10.

The embodiment depicted in FIG. 1 includes aftercooler assembly 60, which is configured to cool graphitized material exiting gravity-fed reactor 20. Aftercooler assembly 60 can in some embodiments include an outlet 70 which can be tapered moving in a downward direction to reduce the diameter of outlet 70. In some embodiments, aftercooler assembly 60 is configured to cool the graphitized material down to about 800° C.

The FIG. 1 embodiment also includes convey or assembly 80 which is in communication with outlet 70 of aftercooler assembly 60. In some embodiments, conveyor assembly 80 is designed to further cool the graphitized material down to about 50° C. In the embodiment depicted in FIG. 1, conveyor assembly 80 is in fluid communication with product collection system 90, which is generally designed to collect and contain graphitized product. In some embodiments, product collection system 90 includes a HEPA-certified filter to ensure that graphitized product does not enter the outside atmosphere.

The FIG. 1 embodiment also shows a furnace programmable logic controller and power supply 95. An advantage of the FIG. 1 embodiment is that it allows for far shorter processing times compared to existing systems in addition to resulting in lower power losses in short low-voltage power lines. Ultimately, the FIG. 1 embodiment provides a graphitization system that has an unexpectedly high power factor, allowing for more efficient use of electricity, and in turn a lower cost per kWh when compared to systems in operation today.

By comparison, the existing Acheson furnace requires manual loading and unloading of powder into graphite crucibles, manual loading and unloading of crucibles into a furnace pile, and long processing times per batch (on the order of 2-3 weeks versus hours with the FIG. 1 embodiment). This results in high power losses, a lower power factor, and in turn a higher cost per kWh. The Acheson furnace also operates at a large temperature gradient, leading to unpredictable quality variation. The Acheson furnace is also far less safe than the embodiment depicted in FIG. 1.

### A. Gravity-Fed Reactor

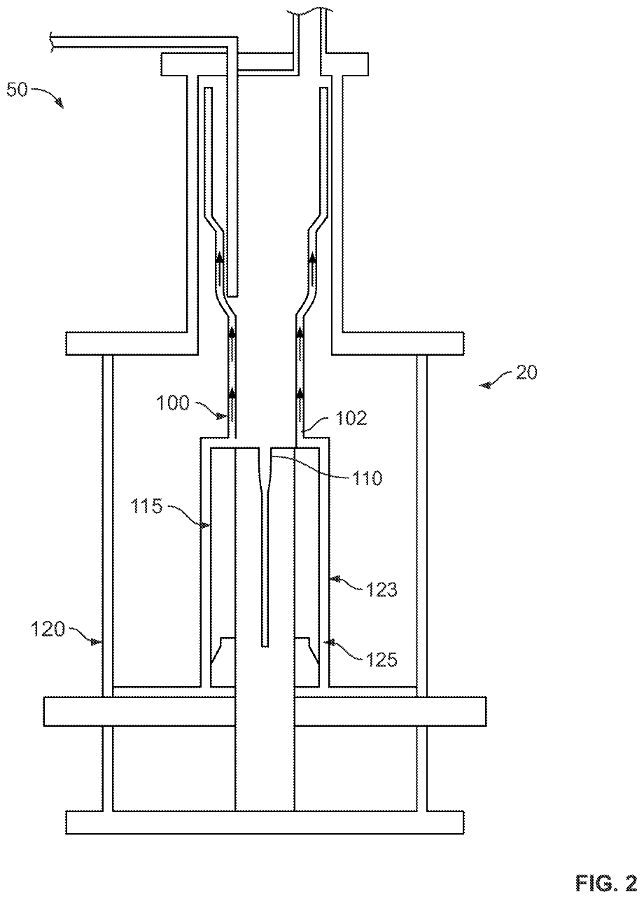

A more detailed view of the FIG. 1 embodiment of gravity-fed reactor 20 (below feed structure 30) is shown in FIG. 2. Gravity-fed reactor 20 has inner tube 100 that defines interior 110. Reactor 20 also has heating assembly 115 that circumferentially surrounds at least a portion of inner tube 100. Heating assembly 115 has at least one heating element configured to apply heat to inner tube 100.

In some embodiments, the at least one heating element comprises at least one resistive heating element. In further embodiments, the at least one heating element comprises a plurality of heating elements positioned to circumferentially surround the at least one portion of inner tube 100. In a specific embodiment, the at least one heating element comprises four heating elements. In some embodiments, the at least one heating element is a graphite electrode, which when resistively heated with direct current can allow interior 110 to reach temperatures suitable for graphitization, e.g., up to and exceeding 3000° C. Other embodiments are contemplated in which the heating assembly is configured to be inductively cooled, particularly for larger scale graphitization processes.

Gravity-fed reactor 20 has outer shell 120 that defines at least lower portion 123 of gas pathway 125, which circumferentially surrounds heating assembly 115. In one embodiment, outer shell 120 comprises insulation material spaced radially outwardly from inner tube 100. The insulation material can be graphite felt.

In one embodiment, gas pathway 125 can be configured to receive helium, while interior 110 of inner tube 100 can be configured to receive argon. An advantage of this embodiment is that it can avoid the use of nitrogen throughout the atmosphere of the reactor, which tends to create wear on reactor components. Thus, in one embodiment, interior 110 of inner tube 100 is fluidly isolated from heating assembly 115 and gas pathway 125, which allows interior 110 to include an inert gas that is different than the inert gas occupying gas pathway 125.

Because of the high temperatures needed for graphitization, in some embodiments, at least a portion or all of inner tube 100, at least the electrode portions of heating assembly 115, and outer shell 120 are made of graphite, which can withstand high temperatures reached in gravity-fed reactor 20.

In one embodiment, inner tube 100 has upper portion 102 that is not circumferentially surrounded by heating assembly 115. In a further embodiment, gas pathway 125 circumferentially surrounds at least a portion of upper portion 102 of inner tube 100.

### B. Feed Structure

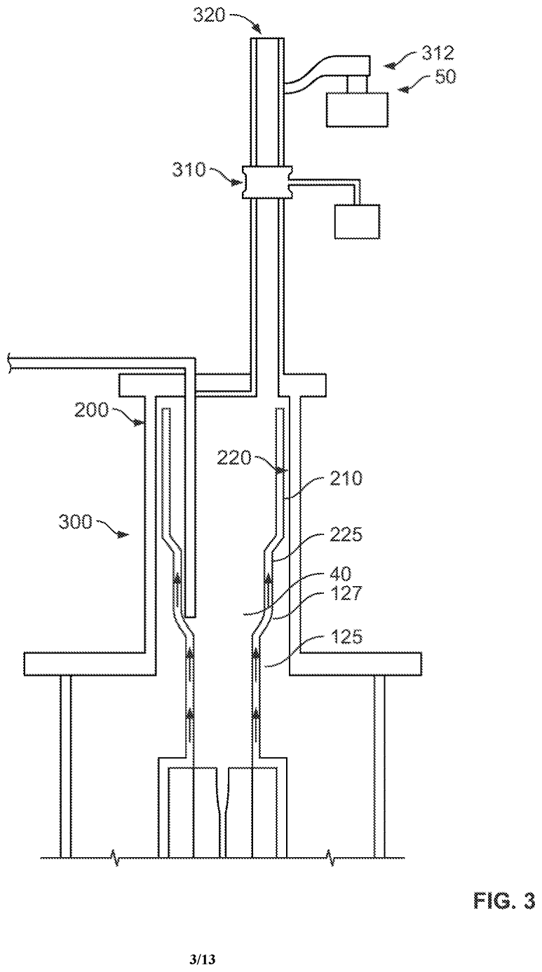

One embodiment of feed structure 30, depicted more generally in FIG. 1, is shown in FIG. 3. Feed structure 30 includes housing 80 and feedstock inlet 210 that defines feedstock receiving space 40 (also shown in FIG. 1). Housing 80 circumferentially surrounds feedstock inlet 210. Housing 80 also defines at least a portion of upper portion 127 of gas pathway 125 (see FIG. 2, which shows lower portion 123 of gas pathway 125). Referring to FIGS. 1-3 collectively, in one embodiment, the boundary between upper portion 127 and lower portion 123 of gas pathway 125 is generally defined as the point where housing 80 of feed structure 30 and outer shell 120 of gravity-fed reactor 20 come together.

Referring to FIGS. 2-3, in one embodiment, at least a portion of upper portion 127 of gas pathway 125 is spaced radially outwardly from inner tube 100 and feedstock inlet 210. In a further embodiment, housing 80 has inner surface 220, feedstock inlet 210 has outer surface 225, and furnace 10 further includes a gas receiving space (not numbered in FIG. 3) defined between inner surface 220 of housing 80 and outer surface 225 of feedstock inlet 210. In one embodiment, the gas receiving space is in fluid communication with gas pathway 125.

In one embodiment, with continued reference to FIGS. 2-3, feedstock inlet 210 has a maximum inner diameter that is greater than a diameter of inner tube 100. Referring to FIGS. 1-3, an advantage of such a design is that during operation, graphitizable material that enters feedstock receiving space 40 of feed structure 30 will be within thermal radiative range of gravity fed reactor 20, and specifically interior 110 of inner tube 100. As part of the graphitization process, portions of graphitizable material that enters the furnace will volatilize in interior 110 of inner tube 100 (e.g., silicon, iron, and the like) and travel upwardly toward and into feedstock receiving space 40. Because feedstock receiving space 40 is significantly colder than interior 110 of inner tube 100, those unwanted portions of the graphitizable material are effectively sequestered by the graphitizable material in feedstock receiving space 40. Once the graphitizable material in feedstock receiving space 40 falls by gravity into interior 110 of inner tube 100, the sequestered portions on the graphitizable material are re-vaporized and again travel upwardly into feedstock receiving space 40.

This phenomenon, rendered possible by the unique design of the embodiments shown in FIGS. 1-3, effectively permits the graphitizable feedstock material to operate, before being graphitized, as a sacrificial cold zone that sequesters unwanted vaporized material. This in turn avoids problems associated with unwanted vaporized material re-condensing onto insulation and other materials, ultimately allowing for the furnace to operate continuously for longer periods of time, particularly relative to a design that requires routine replacement of parts due to deposition of typically conductive alloys from the graphitizable material onto parts intended to be insulating.

### C. Feedstock Transfer System

Referring to FIGS. 1 and 3, furnace 10 can include feedstock transfer system 50 that is in fluid communication with feedstock receiving space 40 of feed structure 30. In one embodiment, feedstock transfer system 50 has at least one valve 310 configured to prevent air from entering feedstock receiving space 40. In one embodiment, feedstock transfer system 50 includes a double dump valve system, including valve 310 in addition to feed valve 312. The double dump valve system allows graphitizable feedstock to enter feedstock transfer system 50, which can then be evacuated of ambient air, and backfilled with an inert gas such as argon. This ensures that the remaining interior portions of the furnace are kept in an inert atmosphere. Thus, in one embodiment, feedstock transfer system 50 can include a negative pressure source 320 that is configured to evacuate air from within feedstock transfer system 50.

### D. Aftercooler and Conveyor Assembly

Referring to FIGS. 1, 2, and 4, furnace 10 can comprise an aftercooler assembly 60 that is configured to cool material exiting inner tube 100 of reactor 20. For example, aftercooler assembly 60 can comprise an inner tube 62 that is in fluid communication with inner tube 100 of reactor 20. In some embodiments, the inner tube of the reactor can extend along a length of the aftercooler assembly and a length of the inner tube 62 of the aftercooler assembly.

The aftercooler assembly 60 can further comprise an outlet 70. In some optional embodiments, at least a portion of the outlet of aftercooler assembly 60 can be tapered moving in a downward direction to reduce a cross section (e.g., a diameter) of the outlet 70.

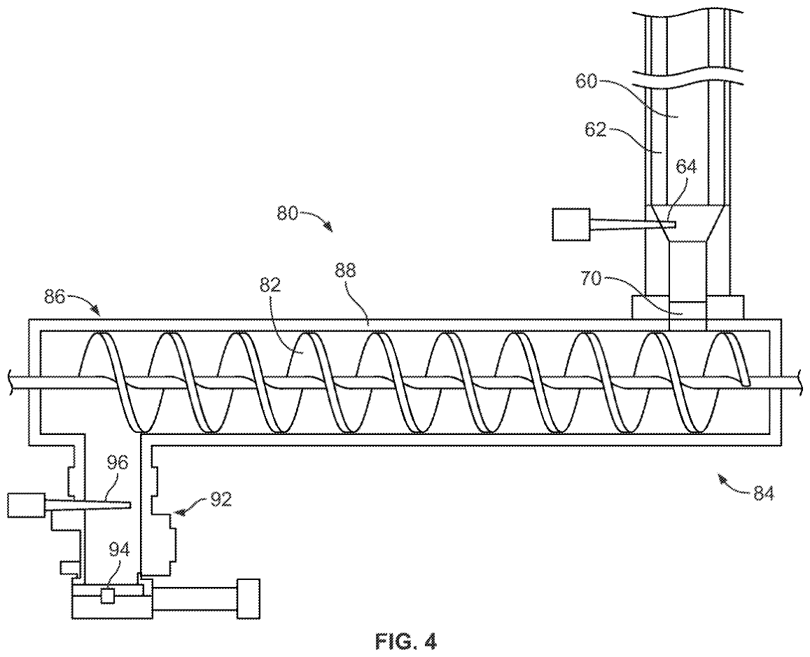

Referring to FIGS. 1 and 4, in some embodiments, the furnace 10 can comprise conveyor assembly 80 in communication with outlet 70 of aftercooler assembly 60. Conveyor assembly 80 can move graphitized material toward product collection system 90. Product collection system 90 can be, for example, a vessel configured to store the graphitized material. In exemplary embodiments, the container of product collection system 90 can be a HEPA-certified collection and containment vessel.

Referring to FIG. 4, in some exemplary embodiments, conveyor assembly 80 can comprise screw 82 and conveyor housing 88. Conveyor assembly 80 can have a first end 84 and an opposed second end 86. Screw 82 can be configured to rotate to convey matter through conveyor housing 88 in a direction from the first end 84 to the second end 86.

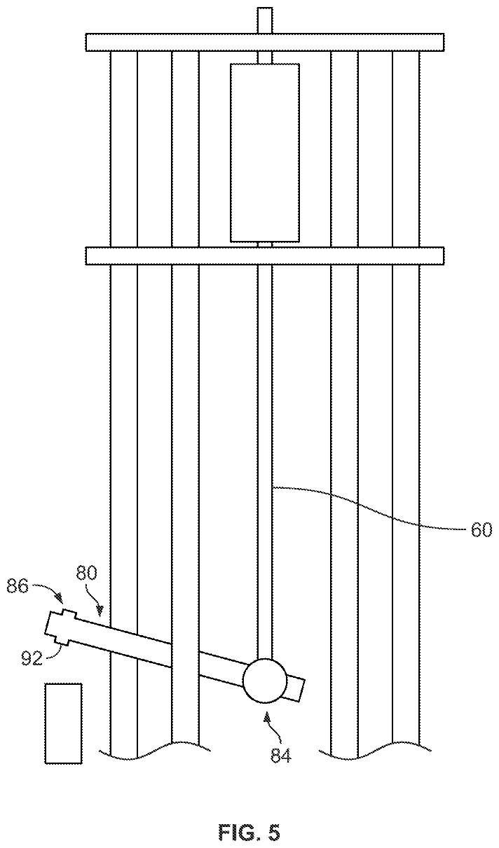

Referring to FIG. 5, in some optional embodiments, screw 82 can be a horizontal or an inclined screw. That is, in some embodiments, screw 82 can extend horizontally or at an incline in the direction from the first end 84 to the second end 86. For example, in some embodiments, screw 82 can form an angle with a horizontal plane from zero degrees to about 45 degrees, or from 0 degrees to about 30 degrees, or from 0 degrees to about 10 degrees, or from 10 degrees to about 30 degrees. In other embodiments, screw 82 can be horizontal.

In some embodiments, screw 82 can be a mass flow screw. Optionally, the mass flow screw can be water-cooled.

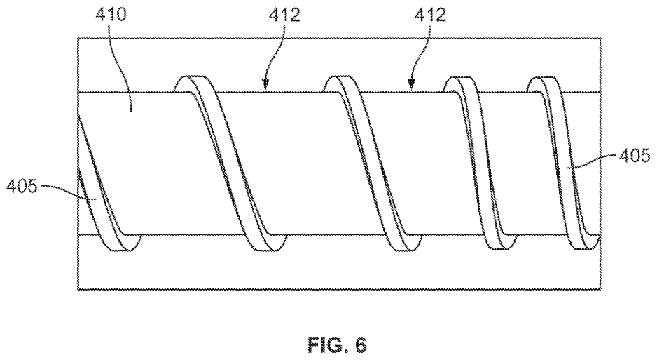

Referring to FIG. 4 and FIG. 6, in some embodiments, screw 82 can comprise one or more threads 405 that have an increasing pitch moving in a horizontal direction away from the reactor (e.g., from the first end 84 to the second end 86). Thread(s) 405 can extend from body 410 of screw 82 to define flights 412 therebetween. Flights 412 can have a sufficient depth (measured radially from body 410 to the outer diameter of the threads to provide sufficient flow through conveyor assembly 80). For example, flights 412 can have a radial depth of at least 1 inch, at least 1.5 inches, at least 2 inches, at least 2.5 inches, at least 3 inches, or more.

Continuing to refer to FIG. 4 and FIG. 6, in some optional embodiments, thread(s) 405 of screw 82 can have an increasing diameter moving in the horizontal direction away from the reactor. That is, thread(s) 405 can extend radially outwardly from a rotational axis of screw 82 by a radius. Thread(s) 405 can gradually or incrementally increase in radius from the rotational axis along the rotational axis of the screw.

Referring to FIG. 4, in some optional embodiments, conveyor housing 88 can have an inner diameter. That is, conveyor housing 88 can optionally have a generally cylindrical interior. Thread(s) 405 of screw 82 can have a maximum diameter. In this way, threads 405 can have a clearance between the inner diameter of the conveyor housing and the maximum outer diameter of screw 82. The clearance can be less than 3 inches, or less than 2 inches, or less than 1 inch, or less than ½ inch, or less than ¼ inch. By limiting this clearance, undesired flow through conveyor 80 can be inhibited. In further embodiments, conveyor housing 88 and screw 82 cooperate to define a bypass area defined by a two-dimensional surface that extends radially from thread(s) 405 to the inner surface of the housing along a single pitch of the thread(s) (one 360 degree travel of the thread) comprising the maximum outer diameter of screw 82. The bypass area can be less than 20, 15, 12, 10, 9, 8, 7, 6, 5, 4, 3, 2, or 1 square inches.

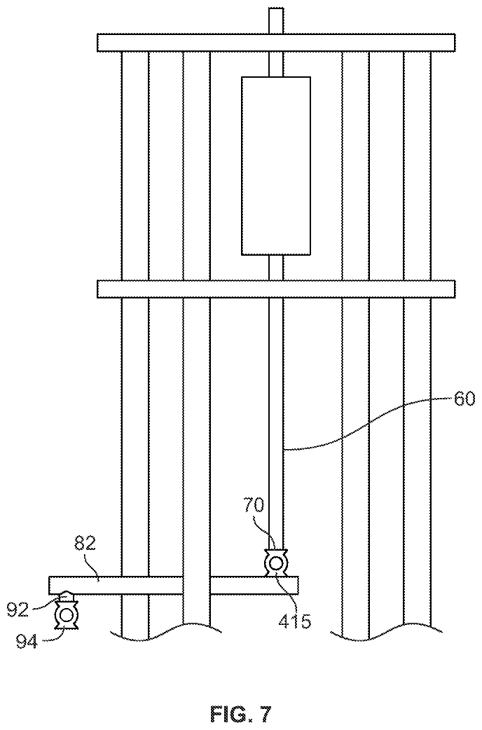

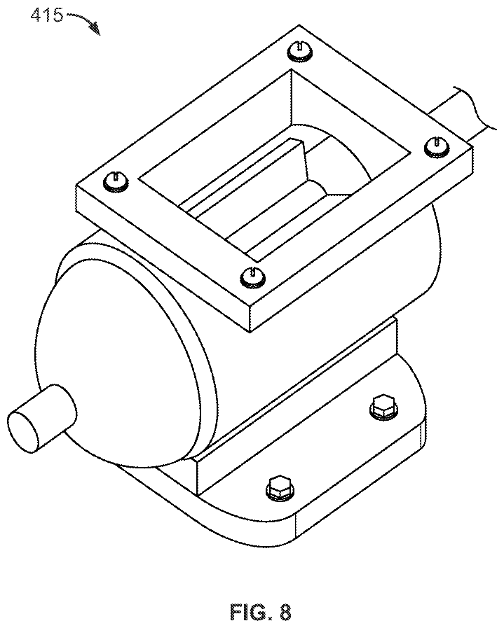

Referring to FIG. 7 and FIG. 8, in some optional embodiments, furnace 10 can comprise a first valve 415 positioned between outlet 70 of aftercooler assembly 60 and conveyor assembly 80. First valve 415 can be configured to control a flow rate of material entering the conveyor assembly.

In further embodiments, conveyor assembly 80 can comprise an outlet 92. Furnace 10 can comprise a second valve 94 that is configured to control a flow rate of material exiting the outlet of the conveyor assembly.

In some embodiments, first valve 415 and/or the second valve 94 can be a rotary valve (FIG. 8). For example, first valve 415 and/or the second valve 94 can comprise a housing and a body comprising a plurality of vanes (e.g., eight vanes) that is rotatable within the housing to meter flow through the housing. In alternative embodiments, first valve 415 and/or the second valve 94 can be butterfly valves (see FIG. 4) or knife gates.

Referring to FIG. 4, optionally, furnace 10 can comprise temperature sensor 96 (e.g., a thermocouple) that is in communication with the interior of conveyor assembly 80. The temperature sensor can be configured to determine a temperature of the graphitized material. In some optional embodiments, the temperature sensor can be configured to determine a temperature of the graphitized material at or proximate to outlet 92. The rate of conveyor assembly 80 can be adjusted to control the temperature of graphitized material leaving outlet 92 of the conveyor assembly. In this way, the graphitized material can be sufficiently cooled to be received in product collection system 90. In further embodiments, temperature sensor 64 can be provided at or proximate to outlet 70 of aftercooler assembly 60. Valve 94 (FIG. 7-8) can deliver graphitized material to conveyor assembly 80 after the thermocouple reaches a sufficiently low temperature (e.g., at or under about 50° C.). In some embodiments, this can avoid damage to conveyor assembly 80.

For example, temperature sensor 96 can be in communication with a computing device (e.g., a PLC). The computing device can be configured to adjust the rate of the conveyor based on a temperature measured by the temperature sensor. For example, the computing device can increase or decrease a rotation rate of screw 82 to increase or decrease flow through conveyor assembly 80.

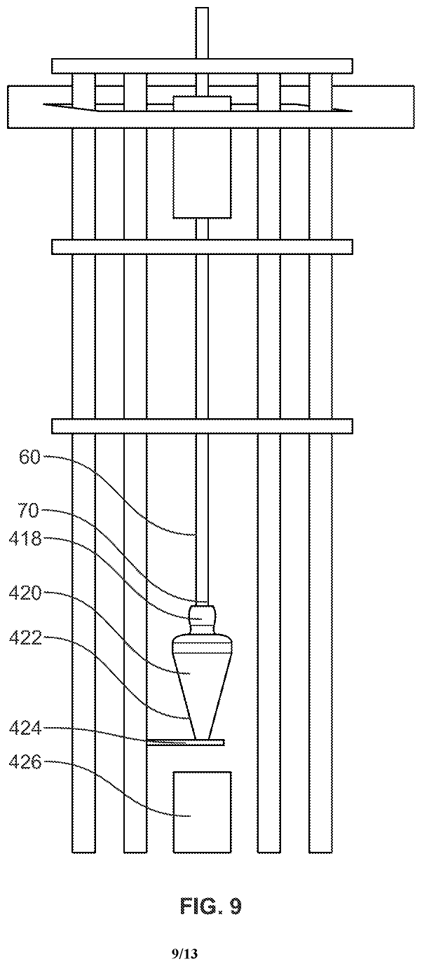

Referring to FIG. 9, in some embodiments, conveyor assembly 80 can be omitted. For example, furnace 10 can comprise a first valve 418 that meters flow from outlet 70 of aftercooler assembly 60. First valve 418 can be a rotary valve. First valve 418 can meter flow into surge vessel 420. Surge vessel 420 can have an outlet 422 in communication with container 426. In further embodiments, a second valve 424 (e.g., a knife gate) can selectively discharge flow from surge vessel 420 to container 426.

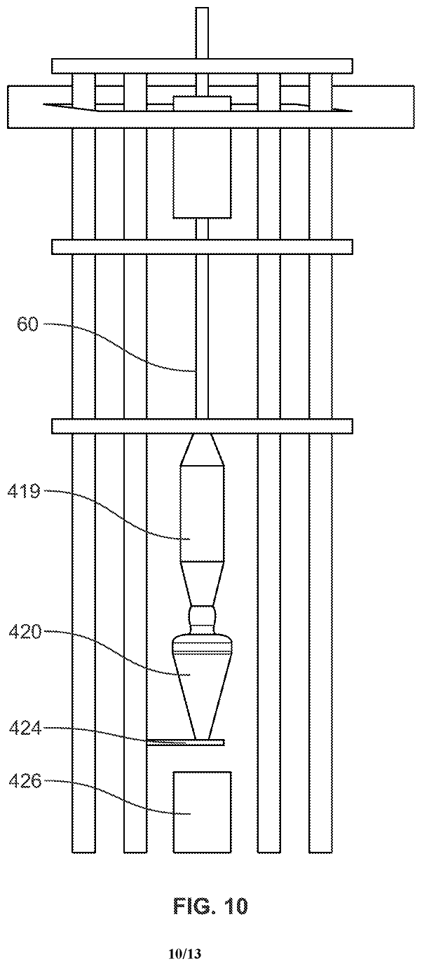

Referring to FIG. 10, in further embodiments, aftercooler assembly 60 can comprise a heat exchanger 419 (e.g., a water cooler) that is configured to remove thermal energy from the aftercooler assembly and, thus, material therein.

In some embodiments, most or all of the components of the graphitization furnace that are exposed to high temperatures (e.g., 800-3000° C. can be made of graphite).

### E. Feedstock

The feedstock for the graphitization furnace can be any graphitizable material. Examples include needle coke, a type of petro-derived coke, natural graphite, other graphite materials, carbonaceous powders (e.g., from 10-300 microns), carbon blacks, including carbon blacks with particle sizes up to several millimeters in diameter, other powderized carbon blacks, brown coal, hard coal, certain plastics, and commodity needle petcoke. Methods of using the graphitization furnace can result in graphite with high-purity flake, in some instances more than 99.99% pure. The graphitized material can be used in a variety of useful applications, including as electrodes for electric vehicles.

### F. Graphite Characterization Device

Also described is a sampling device for characterizing graphitized material. The sampling device is suitable for use with any embodiment of the disclosed graphitization furnace or any other graphitization reactor. In general, the sampling device uses a fixed focal distance optical alignment system for material characterization, which can be any such system, e.g., a Raman-based microscopy system. In one embodiment, the disclosed graphitization reactor (or any other graphitization reactor) can further comprise an optical sampling device that is configured to measure properties of graphitized material after the material passes through the reactor. A controller can be configured to receive an input indicative of the measured properties of the graphitized material. In a further embodiment, the controller can be configured to modify operation of the disclosed furnace (or any other reactor) based on the measured properties of the graphitized material.

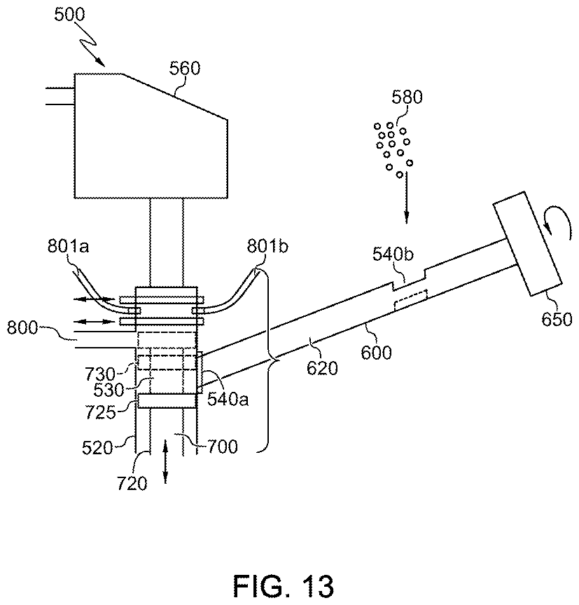

FIG. 13 depicts one exemplary embodiment of the sampling device. The sampling device 500 generally includes a body 520 defining a sample receiving space 530. The sample receiving space 530 can be in communication with a sample collection port 540. The sample receiving space 530 can include a sample support surface 550. The sampling device 500 also includes a fixed focal distance optical alignment system 560 for measuring properties of a stream of input material such as graphitized material from a furnace. The optical alignment system 560 can include for example a Raman-based system such as a confocal Raman microscope system. The sample collection port 540 (a, b) can be configured to receive a sample from a stream of material 580 (e.g., graphitized material) and permit delivery of the sample to the sample support surface 550 within the sample receiving space 530, and the optical alignment system 560 can be configured to measure properties (e.g., the extent of graphization through spectroscopy methods) of the sample when the sample is supported on the sample support surface 550.

In a further embodiment of FIG. 13, the sampling device 500 includes a sample collection tube 600 coupled to and extending outwardly from the body 520 defining the sample receiving space 530. The sample collection tube 600 can feature an interior space 620 in communication with the sample receiving space 530 of the body 520 such that the collection tube 600 is in communication with or defines the sample collection port 540a. In the embodiment shown in FIG. 13, the sample collection tube 600 can be selectively moveable, in this instance rotatable by rotational actuator 650 coupled to the sample collection tube 600, to a collecting position in which a portion of the sample collection port 540b becomes positioned to receive a sample from a stream of material 580 and allow the material to pass into the sample receiving space 530, and onto the sample support surface 550.

The rotational actuator 650 can be configured in some embodiments to rotate the entire sample collection tube 600. In this embodiment, the rotational actuator 650 can rotate the sample collection tube 600 such that sample collection port 540b becomes positioned to receive sample from a stream of material 580 (e.g., graphitized material). The sample collection tube 600 can be configured such that material that enters the sample collection port 540b can flow along a material flow axis (e.g., by gravity or any other physical or mechanical mechanism) to the sample receiving space 530 and only the sample support surface 550.

In some embodiments, the stream of material 580 moves in a first direction along the material flow axis, wherein in the collecting position, the sample collection port 540 of the sample collection tube 600 is positioned upstream of the sample receiving space 530 of the body 520 along the material flow axis, e.g., the material 580 can flow downward by gravity into the sample receiving space 530. In one embodiment, the first direction is a downward direction, where the material flow axis is a vertical axis. Thus, in the sample collective position, the sample collection port 540b of the sample collection tube 600 is positioned above the sample receiving space 530 of the body 520 along the vertical axis. In one embodiment, when material 580 for sampling flows downward toward the sample collection tube 600, the sample collection port 540b of the sample collection tube 600 faces in an upward direction along the vertical axis. In general, once sample is collected, the rotational actuator 650 can return the sample collection tube 600 to a closed position such that material can no longer enter sample collection port 540b.

In another embodiment, the rotational actuator 650 can be configured to rotate only a distal portion (not separately shown in FIG. 13) to return the sample collection tube 600 to an open or receiving position, while another portion of the sample collection tube that is proximal the device body 520 (also not shown) remains stationary. Other embodiments are contemplated; for example, the sample collection tube 600 can remain stationary and any part of the sample collection port 540 (a, b) can be selectively opened or closed to permit sample into the sample receiving space 530 and onto the sample support surface 550.

In a further embodiment, the device 500 can comprise a plunger 700 that is selectively moveable within the sample receiving space 530. In one embodiment, the plunger 700 can define the sample support surface 550. In a further embodiment, the device 500 can further comprise a compression structure 720 position within the sample receiving space 530 of the body 520 between the plunger 700 and the fixed focal distance optical alignment system 560, such that the compression structure 720 is selectively moveable between an open position 725 and a closed position 730. In the closed position 730, the compression structure 720 does not permit passage of the sample and is configured to cooperate with the plunger 700 to compress the sample when the plunger 700 is advanced toward the fixed focal distance optical alignment system 560. The compression structure 720 in some embodiments can comprise an actuated block or blind.

In a further embodiment, the body 520 can define a sample outlet port 800 in communication with the sample receiving space 530. In other embodiments, the body 520 defines at least one sweep port (801a, 801b) positioned between the sample outlet port 800 and the fixed focal distance optical alignment system 560. At least one sweep port (801a, 801b) can be configured to receive gas that flows through the sample receiving space 530 to cause the sample to exit the sample receiving space 530 through the sample outlet port 800. In another embodiment, the device can further comprise a shield structure positioned within the sample receiving space 530 of the body 520 between the plunger 700 and the fixed focal distance optical alignment system 560. The shield structure can be selectively moveable between an open position and a closed position, such that in the closed position, the shield structure does not permit passage of the sample and is configured to direct gas entering the at least one sweep port (801a, 801b) toward the sample outlet port 800.

The graphite characterization device, as discussed above, can be part of a system that includes the graphitization furnace described above or any suitable graphitization reactor. The sampling device can be configured such that the collection port of the sample device is positioned to receive a sample from a stream of material produced by the disclosed graphitization furnace or any suitable graphitization reactor. It is specifically contemplated that the reactor can be any embodiment of the disclosed gravity-fed reactor of the graphization furnace.

Also described are methods comprising performing a reaction within a reactor to produce a stream of material, e.g., graphitized material; and receiving, within the sample collection port of the sampling device, a sample from the stream of material. In one embodiment, the reaction can be a graphitization reaction. In a further embodiment, the reactor can be the disclosed gravity-fed reactor of a graphitization furnace.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or examples.

What is claimed is:

1. A furnace comprising:
a gravity-fed reactor having:
an inner tube defining an interior;
a heating assembly that circumferentially surrounds at least a portion of the inner tube, wherein the heating assembly has at least one heating element that is configured to apply heat to the inner tube;
an outer shell that defines at least a lower portion of a gas pathway that circumferentially surrounds the heating assembly; and
a feed structure configured to receive feedstock, the feed structure defining a feedstock receiving space that is in communication with the interior of the inner tube of the reactor,
wherein the interior of the inner tube of the reactor is fluidly isolated from the heating assembly and the gas pathway.

2. The furnace of claim 1, wherein the inner tube has an upper portion that is not circumferentially surrounded by the heating assembly, and wherein the gas pathway circumferentially surrounds at least a portion of the upper portion of the inner tube.

3. The furnace of claim 1 or claim 2, wherein the feed structure comprises a housing and a feedstock inlet that defines the feedstock receiving space, wherein the housing circumferentially surrounds the feedstock inlet, and wherein the housing defines at least a portion of an upper portion of the gas pathway.

4. The furnace of claim 3, wherein at least a portion of the upper portion of the gas pathway is spaced radially outwardly from the inner tube and the feedstock inlet.

5. The furnace of claim 3 or claim 4, wherein the housing has an inner surface, wherein the feedstock inlet has an outer surface, wherein the furnace further comprises a gas receiving space defined between the inner surface of the housing and the outer surface of the feedstock inlet, and wherein the gas receiving space is in fluid communication with the gas pathway.

6. The furnace of any one of the preceding claims, wherein the at least one heating element comprises at least one resistive heating element.

7. The furnace of any one of the preceding claims, wherein the at least one heating element comprises a plurality of heating elements that are positioned to circumferentially surround the at least a portion of the inner tube.

8. The furnace of claim 7, wherein the plurality of heating elements comprises four heating elements.

9. The furnace of any one of the preceding claims, wherein the outer shell comprises insulation material, and wherein the insulation material is spaced radially outwardly from the inner tube.

10. The furnace of any one of claims 3-9, wherein the feedstock inlet has a maximum inner diameter that is greater than a diameter of the inner tube.

11. The furnace of any one of the preceding claims, further comprising a feedstock transfer system that is in fluid communication with the feedstock receiving space of the feed structure.

12. The furnace of claim 11, wherein the feedstock transfer system comprises at least one valve that is configured to prevent air from entering the feedstock receiving space.

13. The furnace of claim 12, wherein the feedstock transfer system comprises a negative pressure source that is configured to evacuate air from within the feedstock transfer system.

14. The furnace of any one of the preceding claims, further comprising an aftercooler assembly that is configured to cool material exiting the inner tube of the reactor.

15. The furnace of claim 14, wherein the aftercooler assembly comprises an inner tube that is in fluid communication with the inner tube of the reactor.

16. The furnace of claim 14, wherein the inner tube of the reactor extends along a length of the aftercooler assembly and a length of the inner tube.

17. The furnace of any one of claims 14-16, wherein the aftercooler assembly further comprises an outlet.

18. The furnace of claim 17, wherein at least a portion of the outlet of the aftercooler assembly is tapered moving in a downward direction to reduce a diameter of the outlet.

19. The furnace of claim 17 or claim 18, further comprising a conveyor assembly in communication with the outlet of the aftercooler assembly.

20. The furnace of claim 19, wherein the conveyor assembly comprises a horizontal or inclined screw.

21. The furnace of claim 20, wherein the screw is a mass flow screw.

22. The furnace of claim 21, wherein the mass flow screw is water-cooled.

23. The furnace of any one of claims 20-22, wherein the screw comprise threads that have an increasing pitch moving in a horizontal direction away from the reactor.

24. The furnace of claim 23, wherein the threads of the screw have an increasing diameter moving in the horizontal direction away from the reactor.

25. The furnace of claim 23 or claim 24, wherein the threads of the screw have a maximum outer diameter, wherein the conveyor assembly further comprises a conveyor housing within which the screw is received, wherein the conveyor housing has an inner diameter, and wherein a clearance between the inner diameter of the conveyor housing and the maximum outer diameter of the screw is less than 20, 15, 12, 10, 9, 8, 7, 6, 5, 4, 3, 2, or 1 square inches.

26. The furnace of any one of claims 20-25, wherein the screw is a horizontal screw.

27. The furnace of any one of claims 20-25, wherein the screw is inclined at an angle of less than 10 degrees.

28. The furnace of any one of claims 20-27, further comprising a first valve positioned between the outlet of the aftercooler assembly and the conveyor assembly, wherein the first valve is configured to control a flow rate of material entering the conveyor assembly.

29. The furnace of any one of claims 20-28, wherein the conveyor assembly comprises an outlet, and wherein the furnace further comprises a second valve configured to control a flow rate of material exiting the outlet of the conveyor assembly.

30. The furnace of any one of the preceding claims, wherein the reactor comprises at least one temperature sensor, and wherein the furnace further comprises a controller that is communicatively coupled to the at least one temperature sensor of the reactor.

31. The furnace of claim 30, wherein the controller is configured to modify operation of the furnace based on a temperature detected by the at least one temperature sensor of the reactor.

32. The furnace of claim 30 or claim 31, wherein the reactor further comprises a confocal Raman microscope that is configured to measure properties of material after the material passes through the reactor, and wherein the controller is configured to receive an input indicative of the measured properties of the material.

33. The furnace of claim 32, wherein the controller is configured to modify operation of the furnace based on the measured properties of the material.
